(19) United States
(12) Patent Application Publication
(10) Pub. No.: US 2008/0250248 A1
(43) Pub. Date: Oct. 9, 2008

(54) Identity Management System with an Untrusted Identity Provider

(76) Inventor: Zeev Lieber, North York (CA)

Correspondence Address: RIDOUT & MAYBEE;SUITE 2400, ONE QUEEN STREET EAST, TORONTO, ON, M5C3B1, CA

(21) Appl. No.: 11/615,989

(22) Filed: Dec. 24, 2006

(51) Int. Cl. H04L 9/00; H04L 9/14; H04L 9/32

(52) U.S. Cl. 713/183; 380/44; 713/182

(57) ABSTRACT

This invention describes an Identity Management system, in which the User uses the same set of credentials to log into multiple Web Service Providers (WSPs). However, unlike in traditional systems, none of the WSPs have to rely on assertions issued by the Identity Provider (IdP). The Identity Provider itself remains agnostic of User's credentials and User's personal information (the Identity). A 3-way cryptographic protocol is employed between the User, the WSP and the IdP that allows credentials re-use without exposing the IdP to any sensitive information.

At the same time, the IdP provides full set of Identity Management services to the User and to the WSP, without knowing the identities it is dealing with.

In addition, the IdP is deprived of ability to manipulate the identity data in any way, thus ensuring the WSP is in full control over the relationship with its customer (the User).

### FIELD OF THE INVENTION

This invention relates to the field of Password Authentication and Identity Management over a computer network. The invention is especially applicable in the scenario of the global Internet, where a Web Service Provider (WSP) and the Identity Provider (IdP) have no ongoing business relationship between them, and therefore, WSP cannot trust an assertion generated by the IdP.

However, the system is also applicable in other Identity Management scenarios, for example as part of an Enterprise Identity Management System, where the IdP is in fact trusted by all Service Providers.

In the text below, Service Provider, Web Service Provider or WSP refer to any online service or a website that provides services to Users that have an account with it, such as an online book store, an auction or a bank. The IdP refers to the Identity Provider, which serves as a single point of storage of User's personal information and login credentials.

### BACKGROUND OF THE INVENTION

Most Identity Management schemes employed as of this writing rely on an assertion generated by the Identity Provider (IdP), regarding validity of User's credentials. The assertion may be generated using a standard method, such as SAML, or any other proprietary mechanism.

In most of these mechanisms, the User tries to access a resource on the WSP, and is redirected to the IdP for authentication. After a successful authentication, the IdP generates an assertion and directs the User back to the WSP. The User would then present the assertion to the WSP, which, being digitally signed, can be validated with a great degree of reliability.

However, nothing prevents a rogue IdP from generating false assertions, thus tricking an WSP into accepting an unauthorised User. Or, the IdP may be acting in good faith, but the security procedures employed by the IdP may be insufficient to provide necessary degree of confidence on the WSP side.

This is why the system where the trust is removed from the IdP is required. Such system can be a candidate for a Global Identity Management system, since no ongoing business relationship, or trust, is required to exist between the WSP and the IdP.

### SUMMARY OF THE INVENTION

The present invention overcomes the trust issues by introducing a cryptographic abilities to the User's side. The User will have a Shared Secret established between himself and each of the WSPs that the User has a relationship with. The IdP will only store this Shared Secret in an encrypted form, so that the IdP itself does not have access to the Shared Secret.

The cryptographic abilities can be seamlessly added to the User's side using JavaScript technology. This way, the proposed Identity Management system can be operated using existing Internet infrastructure. A more secure way of implementing this system is by putting the cryptographic code in a Browser plugin, or in the Core Browser code. This has the advantage of depriving the IdP of the ability to inject Trojan JavaScript code into User's script.

The User only has one Username and one Password, which are used to access the system. Other types of authentication are also suitable for this purpose, as long as they can be used for encryption and decryption.

Since the User may have relationship with numerous WSPs, and each relationship like this will have a separate Shared Secret, the Shared Secret should be encrypted with a Master Key (or Master Secret), which, in turn, can be encrypted with User's password. This will make password change easier, since only the Master Key will be re-encrypted.

In order to authenticate to a WSP, the User will retrieve the encrypted data from the IdP, calculate the Shared Secret, and present the Shared Secret to the WSP.

The WSP, upon receiving the Shared Secret, will obtain his own copy of it, either from the IdP (using a similar sequence from its side), or from local storage, and compare the two secrets. If the two secrets are equal, the login is successful. The WSP will then proceed to retrieve the User's Personal Data from the IdP.

The User's Personal Data can be encrypted field-by-field, and the keys will be granted by the User to the WSP(s) of User's choice. This will deprive the IdP of the knowledge about its Users and the various WSPs they have relationship with.

Several improvements can be made to this basic protocol to weaken the trust bond between the WSP and the IdP even more. Those imporvements are:
1. If the WSP stores the Shared Secret on the IdP, then the WSP will digitally sign the association of each user and the Shared Secret, so that it cannot be substituted by the IdP.
2. The WSP can digitally sign the Personal Data of the User, to make sure the data is not changed or substituted.
3. The IdP can digitally sign each association of the User and WSP's Shared Secret, and the signature will be stored by the WSP.
4. If the WSP has signed User's personal data, then each time the User updates his data, the data is presented to the WSP for re-signing. This is done by the User, and not by the IdP. The User is required to first establish a session with the WSP by logging in. This makes sure that it is the real user who is initiating the update, and not the IdP.
5. Once an update to User's Personal Data is made, and the WSP is notified (in case of Signed Personal Data), the WSP can present the data back to the User for approval. This will make sure that the IdP did not manipulate the data during the update process.

### BRIEF DESCRIPTION OF THE DRAWINGS

Reference will now be made to the drawings, which show by way of example, embodiments of the invention, and in which:

FIG. 1 is an interaction diagram showing the sequence of events during the Registration Protocol;

FIG. 2 is an interaction diagram showing the sequence of events during the Login Protocol; and

FIG. 3 is an interaction diagram showing the sequence of events during the Update Protocol.

### DETAILED DESCRIPTION OF THE EMBODIMENTS

This section gives an example implementation of the protocol described above. No assumption is made of the technology used on the User's side, which can be JavaScript, Browser Plugin, Core Browser code or a separate Desktop Application. The section gives the detailed flow of the protocol for Registration, Login and Update cases.

The descriptions below assume that the User have an account established with an IdP. Such account will hold an ecrypted Master Secret value X=PBE_enc(P, M), where P is User's password and M is User's Master Secret.

In addition, an option is given to the WSPs to require an Authorization Token A to be provided by the User. This is an arbitrary secret value, given by the WSP to the User out-of-band (e.g. received by the User in person in his banking branch) in order to verify the identity of the physical person doing the registration.

For WSPs that maintain their own information about the User (such as handling banking account), the value C can be supplied by the User to indicate his account number. This value is not mandatory if A is present (since it can be retrieved by the WSP using A as a key), but included for illustration purposes.

In the examples below, the Shared Secret S is generated on the User's side.

### Registration

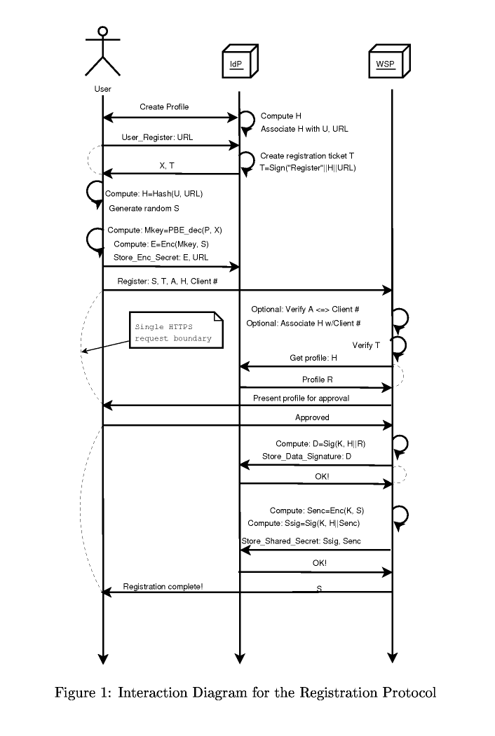

This protocol is invoked when the user first registers with the Service Provider. The complete protocol is shown on FIG. 1.

The flow is as follows:
1. The user arrives at the WSP website and follows the “register” link.
2. The user is directed to IdP registration page.
3. The IdP displays all relevant information for the registration process, and lets the User adjust the Personal Data if necessary.
4. IdP computes: H=Hash(U∥URL) where U is the Username, and URL is the complete URL of the WSP the user is trying to register with. Hash is some secure hash algorithm, like SHA2-256 or better.
5. IdP creates a Registration Ticket T: T=Sign(“Register”∥H∥URL)
6. IdP returns to the user the values of X (Encrypted Master Secret) and T
7. User re-computes the value of H: H=Hash(U∥URL).
8. Optionally, the user enters the values of his Authorization Token A and his client number C with the WSP (like account number in bank).
9. The user decrypts his master key by computing: M=PBE_decrypt(P, X)
10. The user generates a Shared Secret S.
11. The user computes encrypted shared secret E: E=Enc(M, S).
12. The user invokes Store_Enc_Secret service of the IdP.
13. The IdP Stores the Encrypted Shared Secret E and associates it with the User.
14. User sends the values of T, A, H, C and S directly to the WSP.
15. WSP verifies registration ticket T using IdP's trusted public key. This way we know that the subscription request is coming from the IdP and not from somebody else.
16. Optionally, WSP verifies A and C against his database, and builds an association between H and C. Now, user's handle H is linked to his account number.
17. WSP invokes Get_Profile service of the IdP. He submits the value of Hand gets back an unsigned profile R.
18. Optionally, WSP presents R back to the user and asks for user's approval.
19. Optionally, the WSP signs the profile by creating Data Signature D: D=Sig(“ProfileSignature”∥H∥R)
20. Optionally, the WSP invokes Store_Data_Signature service of the IdP. IdP stores the value of D in the database.
21. The WSP encrypts the value of S with his symmetric key K: Senc=Enc(K, S).
22. The WSP signs the encrypted value: Ssig=Sig(“EncryptedSecret”∥Senc).
23. The WSP invokes the Store_Shared_Secret service of the IdP to store the encrypted secret and the signature.
24. The WSP signals that the Registration is successful.

### Login

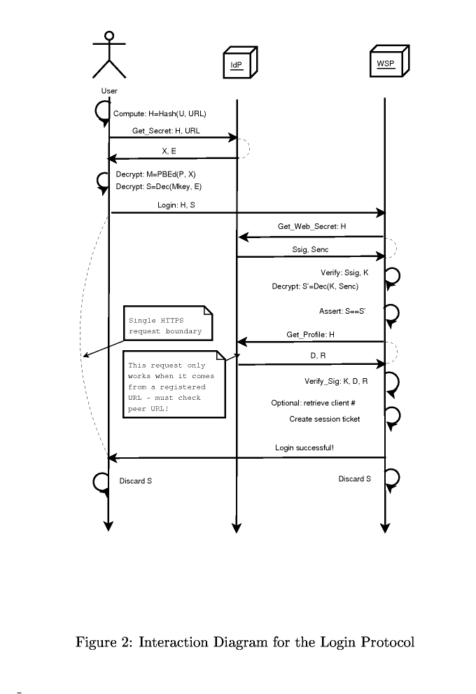

This protocol is invoked each time the user needs to log into a website. See FIG. 2 for details.
1. The user computes the handle H: H=Hash(U∥URL).
2. The user invokes the Get_Secret service of the IdP, passing the URL. IdP can compute H on its own, since the user is already logged in.
3. If the user is not registered with the website in question, he is redirected to the registration protocol. Otherwise, the values of Encrypted shared secret E and Encrypted master key X are returned back.
4. The user decrypts his master key M: M=PBE_dec(P, X)
5. The user decrypts his shared secret S: S=Dec(M, E)
6. The user discards the value of M.
7. The user sends the values of H and S directly to the WSP.
8. The WSP invokes the Get_Web_Secret service of the IdP, passing the value of H.
9. The IdP returns the signed and encrypted shared secrets Ssig and Senc.
10. The WSP verifies the signature Ssig to make sure that correct shared secret was returned.
11. The WSP decrypts the shared secret using his symmetric key K: S′=Dec(K, Senc)
12. The WSP verifies that S′=S. This means that the user has successfully decrypted his shared secret, meaning he knows his master key, meaning he knows his password.
13. The WSP invokes the Get_Profile service of the IdP, passing the value of H.
14. The IdP looks up the profile R and returns it. Optionally, it returns Data Signature D.
15. Optionally, the WSP verifies the signature D.
16. Optionally, the WSP retrieves this user's client number and builds the association between it and the current session.
17. WSP creates HTTP session and signals login success back to the user.
18. WSP and user discard the value of S.

### Profile Update

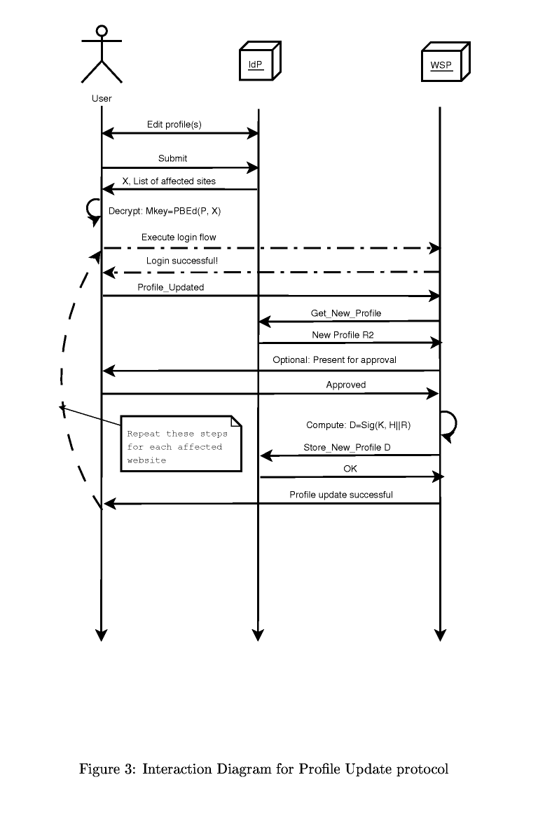

This protocol is invoked each time the user makes changes to his personal data, like modifying address or credit card number. See FIG. 3.
1. The user logs into IdP and makes changes to his profiles.
2. The users indicates that he is done making changes, and he now wants to commit the data to the various websites he is registered with.
3. The IdP calculates the list of updated websites and the particular changes that will be visible to them.
4. From that list, the IdP selects websites registered for Profile Verification. If that list is empty, the protocol is over.
5. If the list is not empty, the IdP returns to the user the list of affected sites, and values of E for each of them. The value of X is also returned.
6. The user decrypts his master key M: M=PBE_dec(P, X).
7. The user goes through the list of the affected websites (using Javascript or browser plugin), and for each of these sites the following steps are performed
   (a) The user performs a complete login flow. Note that he doesn't need to enter his password each time, as the master key is already decrypted and stored in some Javascript variable.
   (b) The user invokes some agreed-upon Profile_Updated service of the WSP, in order to notify them that the data was updated.
   (c) The WSP invokes Get_New_Data of the IdP, passing H.
   (d) The IdP looks up the new profile R₂ and returns it to the WSP.
   (e) Optionally, the WSP can present the profile back to the user and ask for user's approval of the changes.
   (f) The user approves the changes, if asked.
   (g) The WSP computes the new Data Signature D₂: D₂=Sig(“ProfileApproval”∥H∥R).
   (h) The WSP invokes Store_New_Profile of the IdP, passing D₂.
   (i) The IdP updates the database, and D₂ becomes D.
8. The user is notified that the update is successful.

The following is claimed:

1. A method of establishing a relationship between the User and the Service Provider (WSP) using User's identity stored by a Third Party (hereafter the IdP), consisting of the following steps:
(a) Generation of a Shared Secret by the WSP
(b) Transmittal of the Shared Secret by the WSP to the User
(c) Encryption of the Shared Secret by the User
(d) Transmittal of the encrypted value by the User to the IdP
(e) Storage of the Encrypted Shared Secret by the IdP

2. A method of authentication of User to the Service Provider (WSP) employing a third party (hereafter the IdP), consisting of:
(a) Retrieval by the User of his encrypted Shared Secret from the IdP
(b) Decryption on User's machine of the said Shared Secret
(c) Transmittal of the decrypted Shared Secret value from User's machine to the WSP
(d) Retieval by the WSP of WSP's own version of the Shared Secret
(e) Decryption of said encrypted Shared Secret by the WSP
(f) Comparison on the WSP side of the two Shared Secrets—one transmitted by the user and one just decrypted.
(g) Granting access to the User in case the Shared Secret values are equal.

3. A method of managing of User's Personal Data by a Third Party (hereafter the IdP) so that the data is not visible to the IdP, consisting of the following steps:
(a) Generation on the User's machine of a set of random Field Encryption Keys
(b) Encryption on the User's machine of each field individually using its own Field Encryption Key
(c) Encryption on the User's machine of each Field Encryption Key
(d) Transmittal of the encrypted Personal Data, together with the set of encrypted Field Encryption Keys to the IdP
(e) Disclosure by the User of selected Field Encryption Keys to WSPs of his choice, to grant access to some of the fields.

4. A method of updating User's Personal Data by the User, consisting of the following steps:
(a) Retrieval by the User of the Encrypted Personal Data from the IdP
(b) Decryption on the User's machine of said Encrypted Personal Data
(c) Editing by the User on User's machine of said Decrypted Personal Data
(d) Re-encryption on User's machine of the modified Personal Data
(e) Transmittal of the said Encrypted Personal Data back to the IdP
(f) Computing by the IdP of the list of WSPs with whom the User has a relationship, and who will be affected by the said modification
(g) Transmittal of the said list of the WSPs by the IdP back to the User
(h) Notification by the User of each of the WSPs of the change in Personal Data.

5. An Identity Management System, comprising methods in claims 1, 2, 3 and 4.

6. The system described in claim 5, where the Shared Secret is generated on the User's side and transmitted to the WSP during the registration step.

7. The system described in claim 5, where the WSP's version of Shared Secret is stored by the WSP itself.

8. The system described in claim 5, where the WSP's version of Shared Secret is stored in an encrypted and/or hashed form by the IdP.

9. The system described in claim 8 where the combination of User Identifier and WSP's Encrypted Shared Secret is digitally signed by the WSP to prevent the possibility of the IdP substituting another User's shared secret.

10. The system described in claim 5, where the combination of User Identifier and WSP's Encrypted Shared Secret is digitally signed by the IdP, and the signature is stored by the WSP, to prevent IdP from denying the relationship between the User and the WSP.

11. The system described in claim 5, where User's version of the Shared Secret is encrypted by User's password using Password Based Encryption

12. The system described in claim 5, where User's version of the Shared Secret is encrypted using a separate key, which in turn is encrypted using User's password.

13. The system described in claim 5, where User's Personal Data is digitally signed by the WSP to prevent the IdP from substituting another User's personal data. The said digital signature will be re-computed by the WSP each time the User's Personal Data is updated.

14. The system described in claim 5, where User's Personal Data is presented back to the User by the WSP for approval when the relationship is first established, and also each time the said Personal Data is updated, in order to prevent the said Personal Data from being modified and/or substituted by the IdP.

15. The system described in claim 5, where the cryptographic abilities on the User's side are implemented using JavaScript served by the IdP, or JavaScript served by the WSP, or via a Browser Plugin, or in the Core Browser code, or in a standalone application.
